(19) United States
(12) Patent Application Publication
(10) Pub. No.: US 2026/0195118 A1
(43) Pub. Date: Jul. 9, 2026

(54) MANAGEMENT OF FUNCTIONAL COMPONENTS WITHIN INDUSTRIAL DIGITAL ARCHITECTURE

(71) Applicant: Sensia Netherlands B.V., Rotterdam (NL)

(72) Inventors: Jeffery P. Anderson, Beaumont (CA); Norman Andrew Weatherhead, Kitchener (CA); Shelby Adam Murrell, Dripping, TX (US); Chris Wainwright, Wombleton (GB); Edward Anthony Gray, Olmstead Township, OH (US); Srikanth G. Mashetty, Houston, TX (US); Derek Meier, Katy, TX (US); Michael John Ross Brown, Calgary (CA); Thony Brito Cardier, Dubai (AE)

(73) Assignee: Sensia Netherlands B.V., Rotterdam (NL)

(21) Appl. No.: 19/444,146

(22) Filed: Jan. 8, 2026

Related U.S. Application Data
(60) Provisional application No. 63/743,500, filed on Jan. 9, 2025.

(51) Int. Cl. G06F 8/65

(52) U.S. Cl. CPC G06F 8/65

(57) ABSTRACT

One implementation of the present disclosure is a digital architecture system including a subsystem configured to execute an operation. The subsystem can include a digital functional component. The system can include an edge device communicatively coupled to the subsystem. The edge device can include a processor configured to determine a desired update for the digital functional component. The processor can retrieve the desired update from a content repository. The processor can determine whether the desired update would interrupt the operation. The processor can install the desired update on the digital functional component, responsive to a determination that the operation would not be interrupted.

### CROSS-REFERENCE TO RELATED PATENT APPLICATIONS

This application claims priority from Provisional Application US Application 63/743500, filed Jan. 9, 2025, incorporated herein by reference in its entirety.

### BACKGROUND

The present disclosure relates generally to digital architectures. More specifically, the present disclosure relates to systems and methods to manage components within a digital architecture for devices in industrial systems, such as gas and oil extraction stations.

### SUMMARY OF THE INVENTION

One implementation of the present disclosure is a digital architecture system including a subsystem configured to execute an operation. The subsystem can include a digital functional component. The system can include an edge device communicatively coupled to the subsystem. The edge device can include a processor configured to determine a desired update for the digital functional component. The processor can retrieve the desired update from a content repository. The processor can determine whether the desired update would interrupt the operation. The processor can install the desired update on the digital functional component, responsive to a determination that the operation would not be interrupted.

### BRIEF DESCRIPTION OF THE DRAWINGS

FIG. 1 is a perspective view of a hydrocarbon site equipped with well devices, according to some embodiments.

FIG. 2 is a block diagram of a control system for the hydrocarbon site of FIG. 1, according to some embodiments.

FIG. 3 is a block diagram of a portion of the control system of FIG. 2, showing a converged controller communicating with field equipment, input devices, and output devices, according to some embodiments.

FIG. 4 is a block diagram of a system including multiple subsystems, the subsystems including digital and non-digital functional components, according to some embodiments.

FIG. 5 is a block diagram of a control system to be implemented on the system of FIG. 4, according to some embodiments.

FIG. 6A is a partial flow diagram of a process for deploying updates on functional components, according to some embodiments.

FIG. 6B is a partial flow diagram of a process for deploying updates on functional components, according to some embodiments.

FIG. 7 is a block diagram of a user interface display, according to some embodiments.

FIG. 8 is a flow diagram of a method for installing historic updates to address an error in a subsystem, according to some embodiments.

FIG. 9 is a flow diagram of a method for deploying simultaneous updates across a subsystem, according to some embodiments.

FIG. 10 is a flow diagram of a method for assigning functional components to subsystems, according to some embodiments.

FIG. 11 is a flow diagram of a method for ensuring compatibility of updates for functional components, according to some embodiments.

### DETAILED DESCRIPTION

Before turning to the FIGURES, which illustrate certain exemplary embodiments in detail, it should be understood that the present disclosure is not limited to the details or methodology set forth in the description or illustrated in the FIGURES. It should also be understood that the terminology used herein is for the purpose of description only and should not be regarded as limiting.

Referring generally to the FIGURES, one embodiment of the present disclosure refers to a digital architecture system for operating an industrial site. The digital architecture includes a plurality of subsystems, each subsystem configured to execute an operation. Each subsystem may include a plurality of digital functional components and/or non-digital functional components. The digital functional components are configured to be run on one or more applications (e.g., on one or more computing devices such as one or more edge devices or cloud computing resources) and execute part of the operation. The non-digital functional components are configured to have a fixed operation (e.g., mechanical operation) within a subsystem. The digital architecture system includes an edge device communicatively coupled to the subsystems. The edge device can be configured to perform updates to functional components, reconfigure hierarchies of subsystems, and/or add subsystems to the digital architecture.

One embodiment of the present disclosure relates to a method for updating a functional component of the digital architecture. The edge device is configured to receive the desired update for the functional component from a user device or from a cloud computing system. The edge device identifies the subsystems of the digital architecture that include the functional component. The edge device determines whether the functional component, if updated, will be compatible with other functional components belonging to the same subsystem(s) as the functional component. If the functional component will not be compatible with other functional components after updating, the edge device determines additional updates to be installed to maintain compatibility. The edge device is configured to install the update(s) to the functional component(s), either individually or simultaneously.

In some embodiments, a system includes a subsystem that contains both a digital functional component and a non-digital functional component. This subsystem is designed to execute operations that involve both types of components. An edge device is communicatively connected to the subsystem. The edge device is responsible for determining a desired update for the digital functional component, retrieving this update from a content repository, assessing whether installing the update would interrupt the ongoing operation, and proceeding with the installation only if it determines that the operation will not be interrupted.

In some embodiments, the edge device determines whether the update would cause an interruption by consulting an architecture registry to verify the presence of the digital functional component within the subsystem. It also examines the hierarchy of the subsystem, as defined in the architecture registry, to identify multiple functional components that depend on the digital functional component. Based on this hierarchy, the edge device assesses whether the update would disrupt the subsystem's operation.

If the hierarchy reveals that several functional components depend on the digital functional component, the edge device checks whether these components are compatible with the desired update in some embodiments. If incompatibility is detected, the edge device identifies and prepares additional updates for these components, installing them simultaneously with the main update in some embodiments.

In some embodiments, the digital functional component itself includes at least one functional element that executes part of the operation. This functional element may be one among several, which can include protocols, adapters, analysis blocks, visualizations, interfaces, configurations, or operating system patches. The digital functional component may have multiple functional elements, each responsible for different parts of the operation, and updates may introduce new functional elements as needed.

The non-digital functional component is configured to perform a mechanical function that contributes to the overall operation in some embodiments. In some configurations, the subsystem hierarchy defines the non-digital functional component as dependent on the digital functional component, meaning the digital component controls the non-digital component's performance.

In some embodiments, the edge device includes a revision registry to store scheduled updates for the digital functional component. This registry can also manage multiple scheduled updates for various functional components within the subsystem, allowing for simultaneous installation. Additionally, the edge device maintains a revision history of past updates for the digital functional component. It can identify and reinstall a specific past update from this history if needed.

In some embodiments, updates can be installed by transmitting them over a network connection between the edge device and the digital functional component. Alternatively, the edge device may upload the update to an external storage device, from which the update is then downloaded to the device hosting the digital functional component.

In some embodiments, the digital functional component is assigned to a domain, which is recorded in a domain registry within the edge device. When a request for an update is made, the edge device uses information about the digital functional component, the desired update, and a user identifier (which indicates the user's domain) to determine whether to proceed. In some embodiments, the update is installed only if the user's domain matches the domain of the digital functional component, and only if the user is authorized to access that domain. Such requests may originate from a user device, which can also display a dashboard with information about the subsystem.

In some embodiments, the system may include additional subsystems, each with its own digital functional component and operational responsibilities. When determining whether an update would interrupt operations, the edge device considers the scheduled installation time, whether the update will disable the digital functional component during that time, and whether the subsystem's expected operations can continue during the installation in some embodiments.

In some embodiments, a method is also described for using an edge device connected to a subsystem with both digital and non-digital functional components. The method involves determining and retrieving a desired update, assessing potential operational interruptions, and installing the update only if the operation will not be disrupted.

In some embodiments,, the edge device includes a processor configured to determine, retrieve, assess, and install updates for the digital functional component, ensuring operational continuity throughout the process.

### Hydrocarbon Site Overview

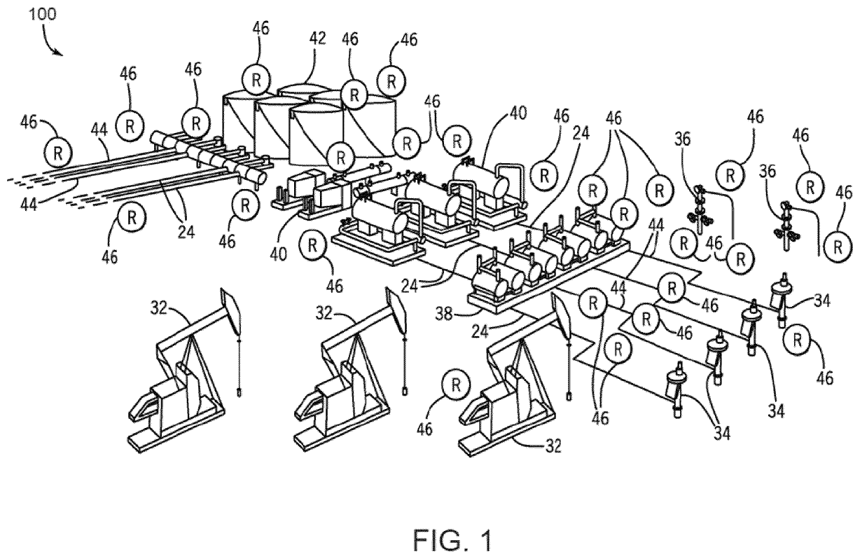

Referring now to FIG. 1, a hydrocarbon site 100 can be an area in which hydrocarbons, such as crude oil and natural gas, can be extracted from the ground, processed, and/or stored. As such, the hydrocarbon site 100 can include a number of wells and a number of well devices that can control the flow of hydrocarbons being extracted from the wells. In one embodiment, the well devices at the hydrocarbon site 100 can include any device equipped to monitor and/or control production of hydrocarbons at a well site. As such, the well devices can include pumpjacks 32, submersible pumps 34, well trees 36, and other devices for assisting the monitoring and flow of liquids or gasses, such as petroleum, natural gasses and other substances. After the hydrocarbons are extracted from the surface via the well devices, the extracted hydrocarbons can be distributed to other devices such as wellhead distribution manifolds 38, separators 40, storage tanks 42, and other devices for assisting the measuring, monitoring, separating, storage, and flow of liquids or gasses, such as petroleum, natural gasses and other substances. At the hydrocarbon site 100, the pumpjacks 32, submersible pumps 34, well trees 36, wellhead distribution manifolds 38, separators 40, and storage tanks 42 can be connected together via a network of pipelines 44. As such, hydrocarbons extracted from a reservoir can be transported to various locations at the hydrocarbon site 100 via the network of pipelines 44.

The pumpjack 32 can mechanically lift hydrocarbons (e.g., oil) out of a well when a bottom hole pressure of the well is not sufficient to extract the hydrocarbons to the surface. The submersible pump 34 can be an assembly that can be submerged in a hydrocarbon liquid that can be pumped. As such, the submersible pump 34 can include a hermetically sealed motor, such that liquids cannot penetrate the seal into the motor. Further, the hermetically sealed motor can push hydrocarbons from underground areas or the reservoir to the surface.

The well trees 36 or Christmas trees can be an assembly of valves, spools, and fittings used for natural flowing wells. As such, the well trees 36 can be used for an oil well, gas well, water injection well, water disposal well, gas injection well, condensate well, and the like. The wellhead distribution manifolds 38 can collect the hydrocarbons that can have been extracted by the pumpjacks 32, the submersible pumps 34, and the well trees 36, such that the collected hydrocarbons can be routed to various hydrocarbon processing or storage areas in the hydrocarbon site 100.

The separator 40 can include a pressure vessel that can separate well fluids produced from oil and gas wells into separate gas and liquid components. For example, the separator 40 can separate hydrocarbons extracted by the pumpjacks 32, the submersible pumps 34, or the well trees 36 into oil components, gas components, and water components. After the hydrocarbons have been separated, each separated component can be stored in a particular storage tank 42. The hydrocarbons stored in the storage tanks 42 can be transported via the pipelines 44 to transport vehicles, refineries, and the like.

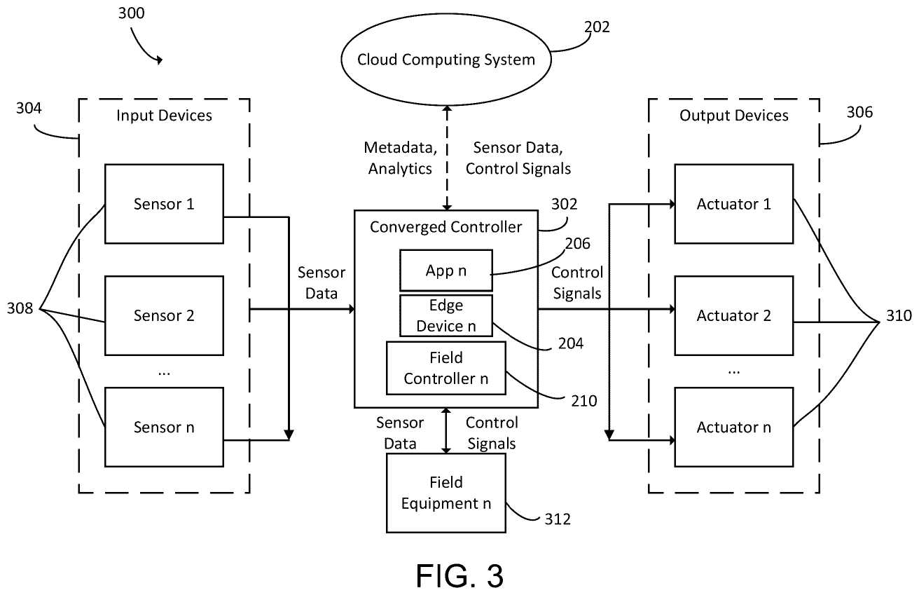

The well devices can also include monitoring systems that can be placed at various locations in the hydrocarbon site 100 to monitor or provide information related to certain aspects of the hydrocarbon site 100. As such, the monitoring system can be a controller, a remote terminal unit (RTU), or any computing device that can include communication abilities, processing abilities, and the like. For discussion purposes, the monitoring system will be embodied as the RTU 46 throughout the present disclosure. However, it should be understood that the RTU 46 can be any component capable of monitoring and/or controlling various components at the hydrocarbon site 100. The RTU 46 can include sensors or can be coupled to various sensors that can monitor various properties associated with a component at the hydrocarbon site 100. In some embodiments, one or more of the RTUs 46 of FIG. 1 are configured as one or more converged controllers 302 as shown in FIG. 3 and described below.

The RTU 46 can then analyze the various properties associated with the component and can control various operational parameters of the component. For example, the RTU 46 can measure a pressure or a differential pressure of a well or a component (e.g., storage tank 42) in the hydrocarbon site 100. The RTU 46 can also measure a temperature of contents stored inside a component in the hydrocarbon site 100, an amount of hydrocarbons being processed or extracted by components in the hydrocarbon site 100, and the like. The RTU 46 can also measure a level or amount of hydrocarbons stored in a component, such as the storage tank 42. In certain embodiments, the RTU 46 can be iSens-GP Pressure Transmitter, iSens-DP Differential Pressure Transmitter, iSens-MV Multivariable Transmitter, iSens-T2 Temperature Transmitter, iSens-L Level Transmitter, or Isens-1O Flexible 1/0 Transmitter manufactured by vMonitor® of Houston, Texas.

In one embodiment, the RTU 46 can include a sensor that can measure pressure, temperature, fill level, flow rates, and the like. The RTU 46 can also include a transmitter, such as a radio wave transmitter, which can transmit data acquired by the sensor via an antenna or the like. The sensor in the RTU 46 can be wireless sensors that can be capable of receive and sending data signals between RTUs 26. To power the sensors and the transmitters, the RTU 46 can include a battery or can be coupled to a continuous power supply. Since the RTU 46 can be installed in harsh outdoor and/or explosion-hazardous environments, the RTU 46 can be enclosed in an explosion-proof container that can meet certain standards established by the National Electrical Manufacturer Association (NEMA) and the like, such as a NEMA 4X container, a NEMA 7X container, and the like.

The RTU 46 can transmit data acquired by the sensor or data processed by a processor to other monitoring systems, a router device, a supervisory control and data acquisition (SCADA) device, or the like. As such, the RTU 46 can enable users to monitor various properties of various components in the hydrocarbon site 100 without being physically located near the corresponding components. The RTU 46 can be configured to communicate with the devices at the hydrocarbon site 100 as well as mobile computing devices via various networking protocols.

In operation, the RTU 46 can receive real-time or near real-time data associated with a well device. The data can include, for example, tubing head pressure, tubing head temperature, case head pressure, flowline pressure, wellhead pressure, wellhead temperature, and the like. In any case, the RTU 46 can analyze the real-time data with respect to static data that can be stored in a memory of the RTU 46. The static data can include a well depth, a tubing length, a tubing size, a choke size, a reservoir pressure, a bottom hole temperature, well test data, fluid properties of the hydrocarbons being extracted, and the like. The RTU 46 can also analyze the real-time data with respect to other data acquired by various types of instruments (e.g., water cut meter, multiphase meter) to determine an inflow performance relationship (IPR) curve, a desired operating point for the wellhead 30, key performance indicators (KPIs) associated with the wellhead 30, wellhead performance summary reports, and the like. Although the RTU 46 can be capable of performing the above-referenced analyses, the RTU 46 cannot be capable of performing the analyses in a timely manner. Moreover, by just relying on the processor capabilities of the RTU 46, the RTU 46 is limited in the amount and types of analyses that it can perform. Moreover, since the RTU 46 can be limited in size, the data storage abilities can also be limited.

In certain embodiments, the RTU 46 can establish a communication link with the cloud-based computing system 12 described above. As such, the cloud-based computing system 12 can use its larger processing capabilities to analyze data acquired by multiple RTUs 26. Moreover, the cloud-based computing system 12 can access historical data associated with the respective RTU 46, data associated with well devices associated with the respective RTU 46, data associated with the hydrocarbon site 100 associated with the respective RTU 46 and the like to further analyze the data acquired by the RTU 46. The cloud-based computing system 12 is in communication with the RTU via one or more servers or networks (e.g., the Internet).

In some embodiments, the best operating point of a submersible downhole pump can be determined by performing an optimization process. For example, model-based optimization or artificial intelligence can be used in order to determine an operating point (i.e., operating pressure, flow, and/or speed of the pump). In some embodiments, the optimization process can include determining the set of wells and the corresponding pump operating points in order to hit a certain production constraint while operating efficiently. In some embodiments, the best operating point can be transmitted to a motor optimization system.

### Site Control System

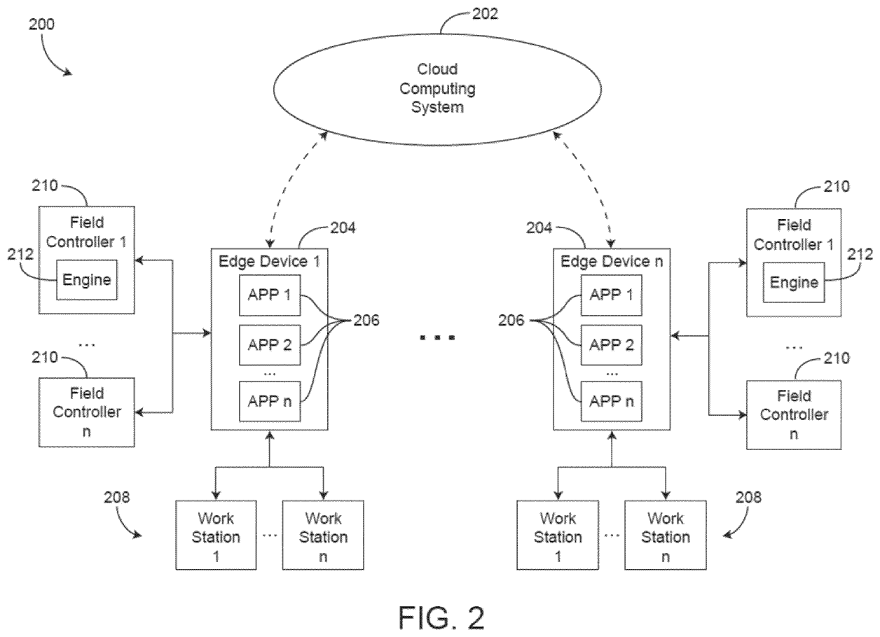

Referring particularly to FIG. 2, control system 200 for hydrocarbon site 100 is shown, according to some embodiments. In some embodiments, control system 200 includes or is configured to communicate with cloud computing system 202 and is configured to control various operations of a well site (e.g., hydrocarbon site 100) based on analyzing metadata from various devices within control system 200. Cloud computing system 202 may include any processing circuitry, processors, memory, etc., or combination thereof that are positioned remotely from hydrocarbon site 100. In various embodiments, some or all of the processing circuity, processors, memory, etc., or combination thereof within cloud computing system 202 may be performed by various devices disclosed within control system 200. Control system 200 is further shown to include edge devices 204, and workstations 208, and field controllers 210. Edge device (n) 204, workstation (n) 208, and field controller (n) 210 as seen in FIG. 2 indicate any number of the edge device 204, workstation 208, and field controller 210 can be implemented in the control system 200.

While cloud computing system 202 is generally disclosed herein as performing some or all of the functionality of the methods disclosed herein, cloud-based architecture (e.g., cloud computing system 202 connected to edge device(s) 204 and field controller 210, etc.) is purely an exemplary embodiment and is not intended to be limiting. In some embodiments, the methods disclosed herein may be implemented by systems that do not include or utilize a cloud-based computing system (e.g., cloud computing system 202). In some embodiments, the systems and methods disclosed herein are architecture agnostic, such that they may be implemented across a variety of architectures including private or on-premise server infrastructure.

Edge devices 204 may be configured to run, perform, implement, store, etc., one or more applications 206 thereof. Application (n) 206 indicates any number of the application 206 can be run on the edge devices 204. Additionally, some or all processing circuity, processors, memory, etc. included in various devices within control system 200 (e.g., edge device 204, field controller 210, workstation 208, etc.) may be distributed across several other devices within control system 200 or integrated into a single device. Edge device(s) 204 may be configured to receive data from field controller(s) 210 and provide data analytics to cloud computing system 202 based on the received data. This is described in greater detail below with reference to FIG. 3.

In some embodiments, each edge device 204 includes a processing circuit having a processor and memory. The processor can be a general purpose or specific purpose processor, an application specific integrated circuit (ASIC), one or more field programmable gate arrays (FPGAs), a group of processing components, or other suitable processing components. The processor is configured to execute computer code or instructions stored in the memory or received from other computer readable media (e.g., CDROM, removable USB drive, network storage, a remote server, etc.), according to some embodiments.

In some embodiments, the memory can include one or more devices (e.g., memory units, memory devices, storage devices, etc.) for storing data and/or computer code for completing and/or facilitating the various processes described in the present disclosure. The memory can include random access memory (RAM), read-only memory (ROM), hard drive storage, temporary storage, non-volatile memory, flash memory, optical memory, or any other suitable memory for storing software objects and/or computer instructions. The memory can include database components, object code components, script components, or any other type of information structure for supporting the various activities and information structures described in the present disclosure. The memory can be communicably connected to the processor via the processing circuitry and can include computer code for executing (e.g., by the processor) one or more processes described herein.

In some embodiments, various edge device(s) 204 may include some or all functionality of remote terminal units (RTUs) (e.g., RTU 46). In various embodiments, edge device(s) 204 is not limited to the functionality of RTU's and can include other controller features. Similarly, RTU's, as described herein, may refer to any industrial edge controller which is programmable and/or capable of one or more applications, either individually or as a module within a broader system (e.g., system 200).

Field controllers 210 may be configured to control various operations at a well site and are communicably coupled with edge devices 204. In some embodiments, field controllers 210 are configured to operate (e.g., provide control signals to, provide setpoints to, adjust setpoints or operational parameters thereof) field equipment (e.g., electric submersible pumps (ESPs), cranes, pumps, etc.) of hydrocarbon site 100. Field controllers 210 may be grouped into different sets based on which edge device 204 field controller 210 communicate with. In some embodiments, edge device(s) 204 are configured to exchange any sensor data, measurement data, meter data (e.g., flow meter data), storage data, maintenance data, control signals, setpoint adjustments, operational adjustments, diagnostic data, analytics data, meta data, etc., with field controllers 210. It should be understood that each edge device 204 can be associated with, corresponding to, etc., multiple field controllers 210.

In some embodiments, one or more of field controllers 210 can include a computing engine 212. Computing engine 212 can be configured to perform various control, diagnostic, analytic, reporting, meta data-related, etc., functions. Computing engine 212 can be embedded in one or more of field controller 210 or may be embedded at one or more of edge devices 204. In some embodiments, any of the functionality of computing engine 212 is distributed across multiple edge devices 204 and/or multiple field controllers 210. In some embodiments, any of the functionality of computing engine 212 is performed by cloud computing system 202.

Still referring to FIG. 2, workstations 208 may be configured to receive user instructions for controlling hydrocarbon site 100 and provide control signals to various devices via control system 200. Workstations 208 can include any desktop computer, laptop computer, personal computer device, user interface, personal computer device, etc., or any general computing device thereof. In some embodiments, multiple workstations 208 (e.g., an n number of workstations 208) are associated with each edge device 204, while in other embodiments, one or more of edge devices 204 are associated with a single work station 208.

In some embodiments, field controller(s) 210 may be configured to act as edge devices such that field controller(s) 210 perform additional processing (e.g., data analysis, mapping, etc.) prior to providing information to cloud computing system 202. In some embodiments, this decreases latency in information processing to cloud computing system 202. In other embodiments, edge device(s) 204 operate as traditional edge devices and perform significant storage and processing within control system 200 (e.g., on-site, at/near hydrocarbon site 100, etc.) to mitigate latency due to processing information in cloud computing system 202.

### Converged Controller

Referring now to FIG. 3, control system 300 for performing control of output devices 306 based on input devices 304 is shown, according to exemplary embodiments. Control system 300 is shown to include a converged controller 302 including edge device 204, application 206, cloud computing system 202, field controller 210, field equipment 312, input devices 304, and output devices 306. Field equipment (n) 312 indicates that any number of the field equipment 312 can be included in the control system 300.

The converged controller 302 can be a device configured to function as and include the edge device 204 and the field controller 210. In some embodiments, the converged controller 302 includes all the functionality of the edge device 204 and the field controller 210. For example, the converged controller 302 can both control equipment and optimize performance of the equipment. The converged controller 302 can be, for example, a HCC2 controller manufactured by Sensia LLC in some embodiments. The HCC2 controller can include analog acquisition hardware and software. In some embodiments, the converged controller 302 includes wired or wireless communication interfaces (e.g., jacks, antennas, transmitters, receivers, transceivers, transmitters, wire terminals, etc.) for conducting data communications with various edge devices, RTUs, converged controllers, and/or cloud computing system 202. For example, the converged controller 302 can include a Wi-Fi transceiver, cellular, or mobile phone communication transceivers for communication via wireless communication network.

Input devices 304 may be configured to provide various sensor data and/or field measurements from hydrocarbon site 100 to the converged controller 302 for processing. For example, sensor 308 of input devices 304 is measuring the pump speed of pump 34. Sensor 308 provides the pump speed of pump 34 to converged controller 302 at regular intervals (e.g., continuously, ever minute, every 5 minutes, etc.). Input devices 304 may be connected wired or wirelessly to converged controller 302 or any other device within system 300. In some embodiments, input devices 304 are coupled to various site equipment (e.g., pumps, pump jacks, cranes, etc.) and provide operational data of their respective site equipment to converged controller 302.

In some embodiments, sensor(s) 308 refer to physical sensors (e.g., temperature sensors, flow sensors, etc.) and/or virtual sensors (e.g., inferential sensors, soft sensors, etc.). In some embodiments, virtual sensors provide identical or similar information as would a physical sensor, only via software applications. In some embodiments, virtual sensors learn to interpret the relationships between the different variables and observe readings from various instruments. For example, rather than implementing several physical sensors at a site (e.g., hydrocarbon site 100), one or more virtual sensors may be placed on a simulation model to achieve identical or similar results.

Output devices 306 may be configured to receive control signals from converged controller 302 and adjust operation based on the received control signals. For example, converged controller 302 determines that pump 34 is operating at a lower pump speed than is considered optimal. The converged controller 302 subsequently sends a control signal to actuator 310 to increase pump speed for pump 34. In some embodiments, output devices 306 are configured to act as any device (e.g., actuator, etc.) capable of adjusting operation of site equipment within hydrocarbon site 100. In some embodiments, various other field equipment (e.g., field equipment 312) include some or all of the functionality of input devices 304 and output devices 306 and provide sensor data and receive control signals from converged controller 302. As seen in FIG. 3, sensor (n) 308 and actuator (n) 310 indicates that any number of the sensor 308 and the actuator 310 can be included and used by the control system 300.

In some embodiments, control system 300 is configured to analyze various sets of data (e.g., metadata) to determine control schema that is optimal for hydrocarbon site 100. A significant amount of processing for this may be performed by converged controllers (e.g., converged controller 302), instead of processing all metadata analytics in the cloud, as processing the data in on-site or proximate edge devices can decrease latency compared to sending the data to cloud computing system 202 for processing. For example, sensors 308 provide metadata to converged controller 302. Converged controller 302 processes the data to determine the type of data and/or domain from which the data is received and analyzes the data. An application within converged controller 302 e.g., application 206) may analyze the metadata to make decisions about the control schema that would have been otherwise unnoticed by processing within control system 300. For example, application 206 may infer that the data received has been received by a flow meter sensor (e.g., sensor (1) 308), based on the patterns seen in the data and a prior data that converged controller 302 has analyzed. Application 206 may make inferences, predictions, and calculations based on current and/or past data.

In some embodiments, application 206 provides some or all of the data to cloud computing system 202 for further processing. Application 206 may be configured to make inferences about received data that improves the standardization of data analytics. For example, sensor (1) 308 and sensor (2) 308 may be flow sensors, but from different vendors. As such, sensor (1) 308 may provide data to field controller 210 in a different format than sensor (2) 308. However, application 206 of the converged controller 302 may still be able to standardize the data and determine that both sets of data are from flow sensors, despite the received data being in different formats (e.g., one data set is provided under resource description framework (RDF) specifications, one data set is provided as data objects, etc.). In various embodiments, allowing converged controller 302 to perform some or all of the metadata analytics allows for improved data analytics and control schema without significantly increasing processing latency.

### Management of Functional Components

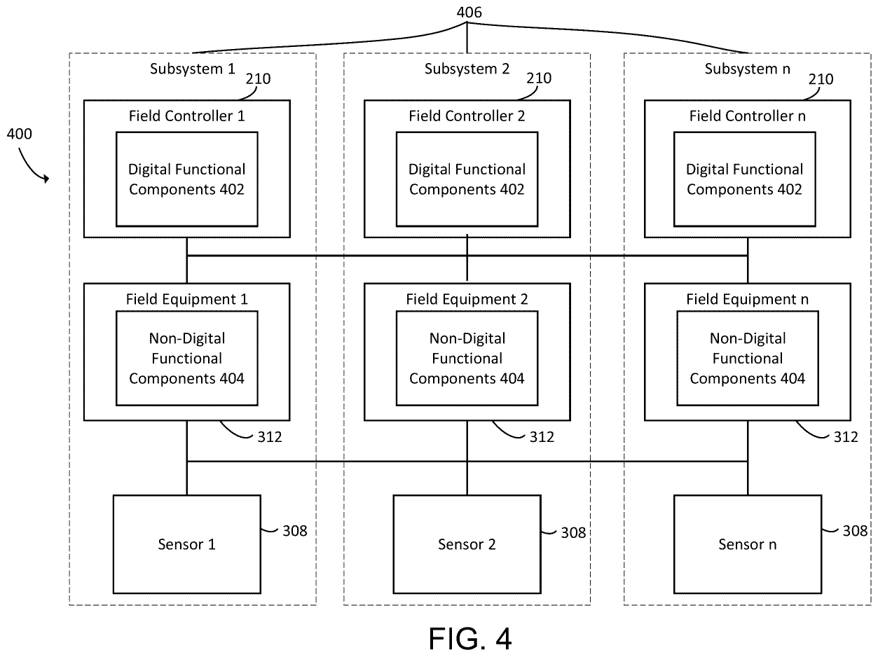

Referring now to FIG. 4, depicted is a digital architecture system 400. In some embodiments, the digital architecture system 400 is configured to be implemented on the hydrocarbon site 100. Digital architecture system 400 includes one or more subsystems 406, configured to achieve an operation. For example, a first subsystem 406 is configured to operate the well devices (e.g., pumpjacks 32) of the hydrocarbon site 100 and a second subsystem 406 is configured to control the flow of hydrocarbons through pipelines (e.g., pipelines 44 of the hydrocarbon site 100).

Each subsystem 406 is shown to include one or more components configured to execute part of the operation. In some embodiments, the subsystem 406 components include a combination of field controllers 210, field equipment 312, and/or sensors 308. In combination, the subsystem 406 components complete the operation. The operation of the subsystems 406 may be dependent on the components that are included in the subsystem 406. For example, a subsystem 406 including a well device can have an operation including pumping hydrocarbons, while a subsystem including pipelines can have an operation including transporting hydrocarbons.

The components of the subsystems 406 can include one or more digital functional components 402. In some embodiments, digital functional components 402 are included in field controllers 210. In some embodiments, digital functional components 402 are included in other subsystem 406 components. Digital functional components 402 are components of a subsystem 406 that are configured to be run on one or more applications and execute part of the operation. For example, a field controller 210 can include a digital functional component 402 that is an algorithm for data processing. As another example, a field controller 210 can include a digital functional component 402 that is a system for data transmission. As another example, a field controller 210 can include a digital functional component 402 configured to determine control settings for one or more non-digital functional components 404.

The digital functional components 402 are configured to be updated or otherwise added to such that the capabilities of the digital functional components 402 can be expanded and/or improved. For example, if a digital functional component 402 is configured to transmit data, the digital functional component 402 can be updated to improve transmission time and/or efficiency. As another example, the digital functional component 402 can be updated to transmit data using a different protocol and/or algorithm, for cybersecurity purposes, etc. As another example, the digital functional component 402 can be updated to provide improved (e.g., more energy efficient, etc.) control settings using an updated control strategy or the like, depending on the function of the digital functional component 402.

The components of the subsystems 406 can include one or more non-digital functional components 404 configured to execute part of the operation. In some embodiments, the non-digital functional components 404 are included in field equipment 312 of the subsystem 406. The non-digital functional components 404 are configured to have a fixed operation within a subsystem 406. For example, non-digital functional components 404 can be hardware components such as actuators, pumps, valves, among other devices. As another example, non-digital functional components 404 can be memory storage components such as hard drives and thumb drives, among other memory devices. As another example, non-digital functional components 404 can be energy storage devices, such as batteries, generators, accumulators, among other devices.

In some embodiments, non-digital functional components 404 can allow for updates to their operating system and/or applications (e.g., firmware). In some embodiments, updates to non-digital functional components 404 are related to changing parameters of current functions of the non-digital functional components. However, non-digital functional components 404 are configured to execute or otherwise complete a fixed part of the operation of the subsystem 406. For example, if the non-digital functional component is a pumping actuator of a well device, the actuator will not be updated to be a valve of the well device. In some embodiments, the non-digital functional components 404 are updated by performing maintenance, repairs, parts replacements, or other physical interventions on the non-digital functional components.

Functional components (e.g., digital functional components 402, non-digital functional components 404) can include one or more functional elements. The functional elements may represent any of as a protocol, adapter, analysis block, visualization, interface, configuration, OS patch, or other element that allows the functional component to operate. When a functional component is updated, the update can include additional functional elements to be added to the functional component. When a functional component is updated, the updates may be updates to specific functional elements within the functional components. By including functional elements in functional components, the data footprint of an update can be reduced by targeting specific functional elements rather than an entire functional component.

Within a subsystem 406, functional components (e.g., digital functional components 402, non-digital functional components 404), as well as other devices (e.g., sensors 308) can be arranged in an operational hierarchy. The hierarchy of the subsystem 406 can be based on the operation and/or a control structure of the subsystem 406. For example, if a digital functional component 402 is included in a field controller 210 that controls a non-digital functional component 404, the digital functional component 402 will be above the non-digital functional component 404 in the hierarchy. Depending on the functional components within a subsystem 406, the hierarchy can be variable or fixed (e.g., not changeable).

In some embodiments, functional components are included in a single subsystem 406. In alternate embodiments, functional components are included in multiple subsystems 406. For example, a field controller 210 can include digital functional components 402 that control field equipment 312 across multiple subsystems 406. The subsystems 406 are configured such that the hierarchy of a first subsystem 406 does not impact the hierarchy of a second subsystem 406, even if the first and second subsystems 406 share functional components. This may allow for a subsystem 406 to be updated or adjusted without impacting the operation of other subsystems.

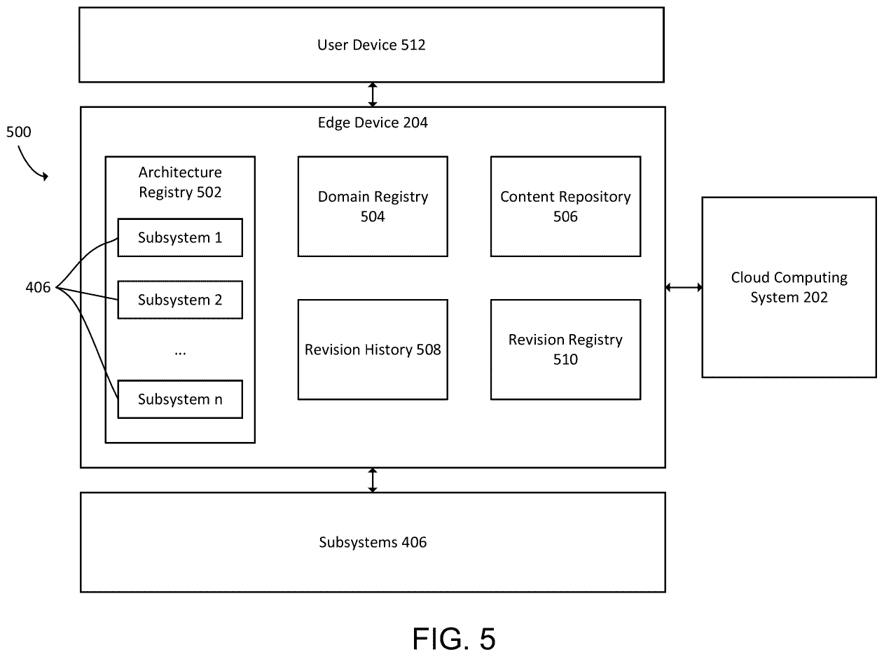

Referring now to FIG. 5, depicted is a system 500 for controlling the subsystems 406, according to some embodiments. The system 500 is shown to include the edge device 204 configured to control the subsystems 406. The edge device 204 includes an architecture registry 502 configured to store the configurations of each subsystem 406. The edge device 204 includes a domain registry 504, configured to store identifying information for each functional component. The edge device 204 includes a revision history 508 configured to store updates for functional components that have already been installed. The edge device 204 includes a content repository 506, including all updates (e.g., functional elements) of the functional components. The edge device 204 includes a revision registry 510 configured to store scheduled updates for functional components.

The architecture registry 502 can be configured to store or otherwise record the configurations of functional components and other devices within a subsystem 406. The architecture registry 502 includes the hierarchy of functional components and functional elements within each subsystem 406, so that relationships between components can be identified. In cases where a functional component is included in multiple subsystems 406, the architecture registry 502 may establish a link between subsystems 406, so that relationships between subsystems 406 can be identified. The architecture registry 502 can indicate the compatibility of functional elements of functional components of a subsystem 406. For example, the architecture registry 502 can identify, based on the stored hierarchy of a subsystem 406, that the functional elements of a first functional component are not compatible with a second functional component (e.g., due to outdated software, unrecognized protocol, etc.).

If the edge device 204 determines, based on the architecture registry 502, that one or more updates to one or more functional components is necessary, the edge device 204 may search (e.g., parse, scan, query, etc.) the architecture registry 502 to determine whether the update will impact other functional components or devices of a subsystem 406 that includes the functional component. If the edge device 204 determines (based on the architecture registry 502) that an update will interrupt the operation of subsystems 406, the edge device 204 may delay the updates to be installed at a time that minimizes interruption to the subsystems 406.

The revision registry 510 is configured to store scheduled updates for functional components for a predetermined time period before installing. In some embodiments, the revision registry 510 is configured to store each scheduled update separately (e.g., for a functional component) and install updates separately regardless of hierarchy. In alternate embodiments, the revision registry 510 may associate scheduled updates (e.g., for multiple functional components within a subsystem 406), and deploy the updates simultaneously to minimize interruption to the subsystem 406 and/or other subsystems 406 that include the functional component.

Some updates of the functional components can temporarily disable or otherwise interrupt the functional component from operating while the update is installing. The revision registry 510 can be configured to determine whether the update will interrupt the functional component. In some embodiments, the edge device 204 stores information relating to operation schedules of each subsystem. For example, a subsystem 406 can be active during the day and dormant during the night. If the edge device determines that the update will interrupt operation of the functional component (and/or the subsystem 406), the revision registry 510 may elect to store updates during the day so that they can be installed at night, thereby avoiding installing updates that would interrupt operation of the subsystem 406 during active time periods.

In some embodiments, an initial update to a functional component may make the functional component incompatible with other functional components in its subsystem 406. To ensure the compatibility of functional components in a subsystem 406, the revision registry 510 may deploy additional updates in a subsystem 406 simultaneously with the initial update so that the functional components in a subsystem remain compatible. For example, if an update for a functional component includes a configuration change that requires the same configuration change on all components of the subsystem 406, the revision registry 510 may simultaneously install the update on all subsystem 406 components.

After installing an update on a functional component, the edge device 204 stores or otherwise maintains the update on the revision history 508. The revision history 508 is configured to track all historical updates for functional components or track historical updates for functional components over a predetermined time period. The revision history 508 may include information relating to historical updates, such as a time of the update, and a functional component that the update was installed on. Based on information stored in the revision history, the edge device 204 may limit the number of updates to a predetermined number of updates in a predetermined time period.

The revision history 508 may be configured to install historical updates to functional components if more recent updates cause errors (e.g., delays, compatibility issues, inefficiency, malfunctions, etc.) in a subsystem 406. For example, if an installed update of a functional component is not compatible with other functional components, the revision history 508 can reinstall a historical update to re-establish compatibility between functional components. If it is necessary to install a historical update (e.g., undo an update), the revision history 508 can log the installation of the historical update as well as an indication of the error that necessitated the historical update. This may allow for a user to view the revision history 508 and identify what caused the installation of the historical update.

Depending on the functional components and/or operation of each subsystem 406, there may be a higher risk (e.g., environmental risk, safety risk) associated with operating, updating, and/or adjusting a subsystem 406 relative to other subsystems 406. In some embodiments, each functional component and/or subsystem 406 may be assigned to a domain. Each domain can have assigned users such that only users with clearance (e.g., access, authorization) to that domain can update or adjust a subsystem 406 and/or a functional component assigned to the domain.

When the edge device 204 receives a request for updating and/or adjusting the configuration of a functional component or subsystem 406, the edge device 204 can identify a domain associated with the update. The domain associated with the update can be based on the functional elements associated with the update or be based on the subsystem 406 itself. The edge device 204 can identify, based on an identifier of the user requesting the update, a domain of the domain registry 504 associated with the user. The edge device 204 can compare the domain of the user to the domain of the update. If the domain registry 504 shows that the domain of the user matches the domain of the update, the edge device 204 can initiate (e.g., authorize, deploy, schedule) the update. If the domain registry 504 shows that the domain of the user does not match the domain of the update, the edge device 204 can block (e.g., deny) the update request.

The content repository 506 includes all of the previously installed updates and functional elements for the subsystems 406. In some embodiments, it is desirable to install the same functional elements on a first functional component and a second functional component. By storing all the functional elements in the content repository 506, the edge device 204 does not need to re-download functional elements before installing the update. The content repository 506 can be configured to store all historical updates and functional elements of the subsystems 406 such that when the edge device 204 installs a historical update based on the revision history 508, the edge device 204 does not need to re-download the historical update.

When an update requires software and/or data that is not stored in the content repository 506, the edge device 204 can request the software and/or data from the cloud computing system 202. The edge device 204 may be communicatively coupled to the cloud computing system 202 such that updates can be downloaded from the cloud computing system 202 onto the content repository 506. The updates may be transmitted wirelessly from the cloud computing system 202 to the edge device 204, or the updates can be downloaded onto an external storage device (e.g., flash drive, USB stick, etc.) and uploaded via a communication port of the edge device 204.

Updates to the functional components can be initiated automatically by the cloud computing system 202. For example, the cloud computing system 202 may determine that an update should be installed to the functional components and initiate the installation without user authorization. In some embodiments, the cloud computing system 202 can initiate updates corresponding to any domain. In alternate embodiments, the cloud computing system 202 can only initiate updates corresponding to pre-authorized domains. Pre-authorized domains may be domains associated with relatively low environmental/safety risk, such that if an error occurred during the automatic installation process, minimal risk is incurred.

Updates to the functional components can be initiated manually by a user interaction with a user device 512. The user device 512 may be configured to transmit a request to the edge device to install an update on the functional components. The request can indicate any of a functional component (for the update to be installed on), a desired update, and an identifier of the user (e.g., domain of the user). In some embodiments, if the cloud computing system 202 tries to initiate an automatic update installation on a functional component with a high-risk domain, the edge device 204 may require user authorization via the user device 512 to initiate the installation. If the user authorization is executed by a user associated with the domain of the update, the edge device 204 can then initiate the update.

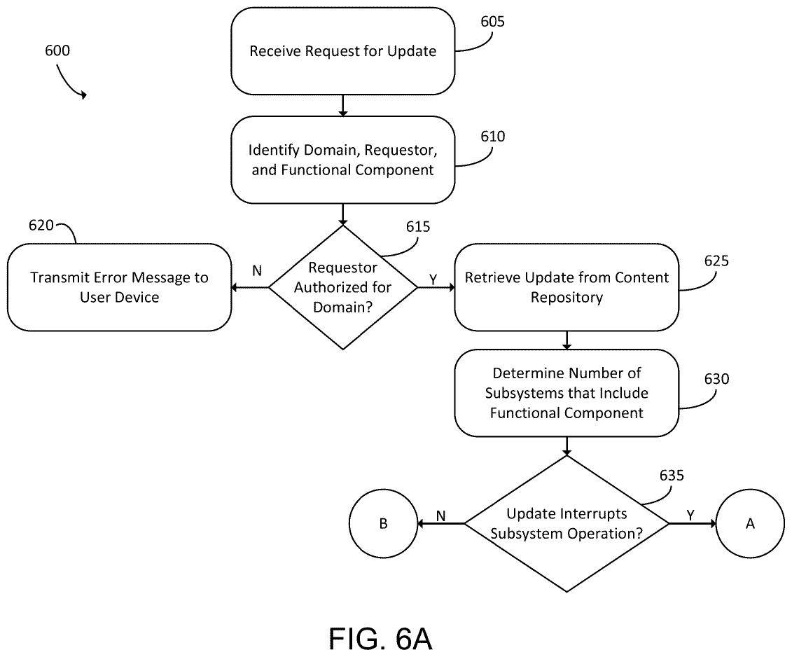

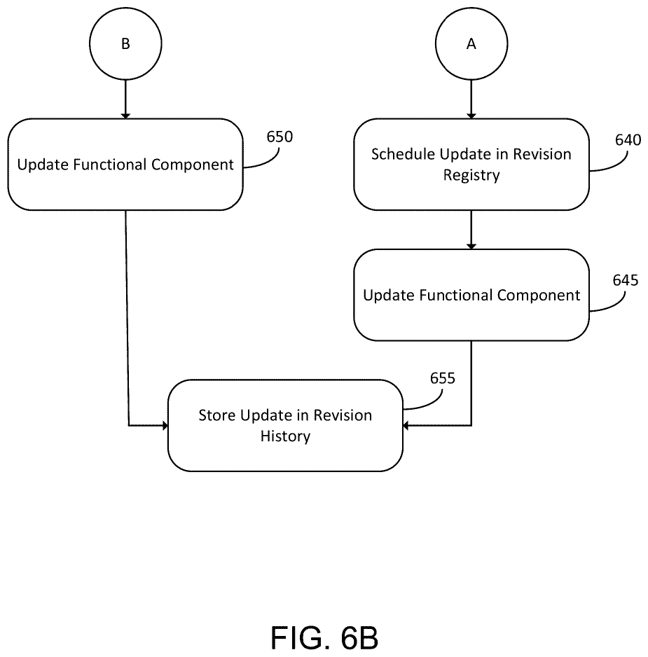

Referring now to FIGS. 6A and 6B, depicted is a flow diagram of a process 600 for updating a functional component, according to some embodiments. In some embodiments, updating the functional component includes additional/fewer steps than depicted in process 600. In some embodiments, the process 600 can be executed in a different order than shown. Referring to FIG. 6A, depicted is a partial flow diagram of the process 600. At step 605, the edge device (e.g., edge device 204) receives a request for an update. The update includes functional elements or other software to be installed on the functional component. If the request is from a user device (e.g., user device 512), the request indicates the functional component, the desired update, and an identifier of the user (e.g., domain of the user). If the request is from a cloud computing system (e.g., cloud computing system 202), the request may indicate the functional component and the desired update. While the description below refers to operations of an edge device, such operations can be executed by one or more edge devices, cloud computing systems, etc. or combination thereof (e.g., distributed across devices and system), in various embodiments within the scope of the present disclosure.

At step 610, the edge device identifies the domain, requestor, and functional component associated with the request. The edge device may search or otherwise use the domain registry (e.g., domain registry 504) to determine the domain associated with the functional component. The domain indicates a risk (e.g., environmental risk, safety risk, other risk) associated with installing updates to the functional component. At step 615, the edge device may compare the domain of the requestor to the domain of the functional component. The comparison of the domain of the requestor to the domain of the functional component indicates whether the requestor is authorized to install updates on functional components belonging to that domain.

At step 620, if the requestor is not authorized to install updates to the domain of the functional component, the edge device transmits an error message to the user device. The error message indicates that the requestor is not authorized to install updates to functional components of that domain. The edge device may then deny the update request and stand by for future requests. At step 625, if the requestor is authorized to install updates for the domain of the functional component, the edge device retrieves the requested update from the content repository (e.g., content repository 506). If the update is not in the content repository, the edge device may request the update from the cloud computing system, and subsequently download the update to the content repository.

At step 630, the edge device determines the number of subsystems that include the functional component. The edge device may use an architecture registry (e.g., architecture registry 502) to determine which subsystems (e.g., subsystems 406) include the functional component. The architecture registry may include information regarding the hierarchy of functional components within subsystems. The hierarchy of functional components may provide an indication of whether the installing the update will interrupt operation of the subsystem and/or whether the update is compatible with other functional components within the subsystem. At step 635, the edge device determines whether the update will interrupt operation of a subsystem and/or is not compatible with other functional components in a subsystem.

Referring to FIG. 6B, depicted is a partial flow diagram of the process 600. At step 640, if the update will interrupt operation of the subsystem (e.g., by disabling the functional component during install), the edge device may elect to delay installation of the update until the subsystem is less active. Upon determining a desired time to deploy the update, the edge device may store the update in the revision registry (e.g., revision registry 510). The revision registry is configured to deploy the update at the desired time, such that interruption to the subsystem(s) is minimized. Still referring to step 640, if the update is not compatible with other functional components in the subsystem(s), the edge device may identify additional updates that can be deployed to make the functional components of the subsystem compatible. After identifying the additional updates, the edge device may store the updates in the revision registry to be deployed simultaneously to the functional components, so that compatibility is maintained.

At step 645, the update(s) are deployed from the revision registry to the functional component(s). Depending on the update(s), the edge device may disable the subsystem(s) during the update time or may allow the subsystem(s) to remain operational if the update(s) can be installed in the background while operation can still be performed successfully. At step 650, if the update does not interrupt operation of the subsystem and does not impact compatibility of the functional component with other functional components, the edge device can install the update on the functional component. At step 655, the edge device stores the update(s) in the revision history (e.g., revision history 508). The revision history can include an indication of the installed update(s), the functional component(s), and/or a timestamp indicating a time that the update was installed.

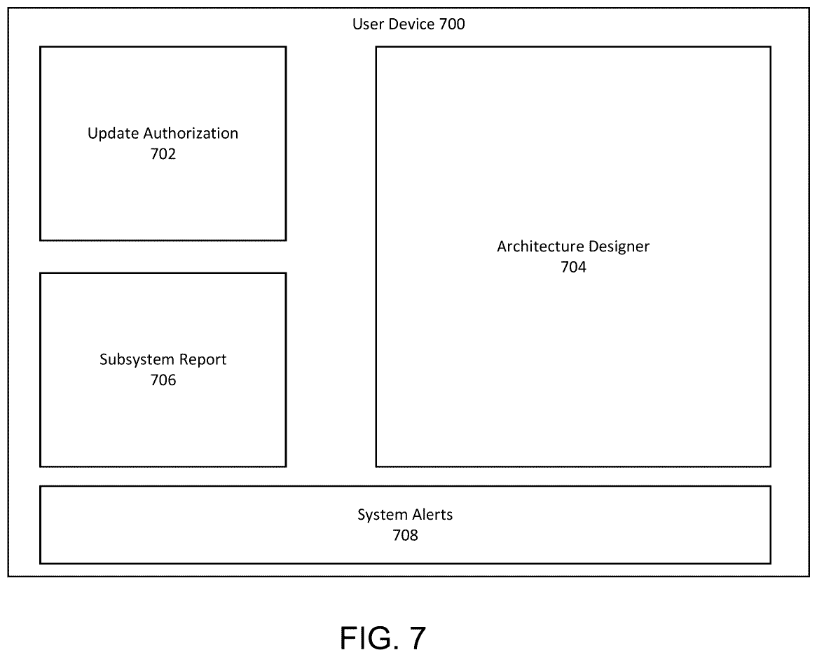

Referring now to FIG. 7, depicted is a user interface display of user device 700, according to some embodiments. User device 700 can include any components and/or capabilities of user device 512 and can include additional components and/or capabilities. User device 700 is shown to include an update authorization 702 configured to allow the user to acknowledge updates to be installed. User device 700 is shown to include architecture designer 704 configured to allow the user to initiate updates for functional components, and reconfigure the architecture of subsystems (e.g., subsystems 406). User device 700 is shown to include subsystem report 706 configured to display information relating to operation of subsystems. User device 700 is shown to include system alerts 708 configured to notify the user of issues relating to the subsystems. Such components of the user device 700 can be implemented as computer-readable instructions stored one or more computer-readable memory components of the user device 700 and executable by one or more processors of the user device 700 to provide the operations described herein.

If an update is automatically initiated that is at a higher-risk domain than the cloud computing system (e.g., cloud computing system 202), the edge device (e.g., edge device 204) may request authorization to the user device 700. Update authorization 702 is configured to display the update request. Update authorization 702 includes a selectable element configured to transmit a message authorizing the request, along with an identifier of the user. Once the edge device receives the request, the edge device determines whether the user is authorized for the domain of the request. If the user is authorized for the domain, the system alerts 708 will display a message notifying the user that the update was authorized successfully. If the user is not authorized for the domain, the system alerts 708 will display a message notifying the user that the update was not authorized successfully.

The architecture designer 704 is configured to allow the user to initiate updates to functional components, reconfigure the architecture of a subsystem, and/or create new subsystems. The architecture designer 704 includes selectable elements that allows a user to select one or more updates to be installed on the functional components. If the user attempts to install an update to a functional component that is unable to support the update, the system alerts 708 can notify the user that the update is not supported. If the user attempts to install an update to a functional component that can support the update, system alerts 708 can notify the user that the update was successful.

The architecture designer 704 includes selectable elements that allows the user to reconfigure the hierarchy of a subsystem. If the user attempts to reconfigure the hierarchy of the subsystem to a hierarchy that causes the subsystem to malfunction, the system alerts 708 can notify the user that the subsystem configuration is not supported. If the user attempts to reconfigure the hierarchy of the subsystem to a hierarchy that achieves the operation of the subsystem, the system alerts 708 can notify the user that the subsystem operates properly. If the reconfiguration is executed successfully, the edge device can store the new configuration in the architecture registry (e.g., architecture registry 502).

The architecture designer 704 includes selectable elements that allows the user to define new subsystems. In some embodiments, the user can define a new subsystem using functional components that are already present in other subsystems. In alternate embodiments, the user can upload or otherwise add functional components to the architecture designer 704 and define new subsystems using present functional components and new functional components. If the user adds subsystems to the architecture designer, the edge device can store the new subsystems in the architecture registry.

The subsystem report 706 can provide the user with information regarding operation of subsystems. As an example, the subsystem report 706 can display sensor data from the sensors (e.g., sensors 308) of each subsystem. The subsystem report 706 can provide metrics associated with field equipment (e.g., field equipment 312) such as flow rate, pressure, temperature, among other values. The subsystem report 706 can include selectable elements configured to allow the user to filter or otherwise search the report for specific items. For example, the subsystem report 706 can include a search bar to search for a specific sensor, field equipment, subsystem, and/or field controller.

In some embodiments, the user device 700 and/or edge device (e.g., edge device 204) is configured to store information related to each subsystem for a predetermined time period. The subsystem report 706 may include a selectable element configured to allow the user to search for subsystem information at a specific time. For example, the user may search the subsystem report 706 for information relating to a subsystem over the previous seven days. This can allow the user to identify trends related to subsystems, and assist the user in making decisions regarding updates and/or configuration changes to subsystems. The subsystem report 706 may also log changes to subsystem configurations over time. The subsystem report 706 can include user entered notes regarding changes to configurations, so that other users can determine why a configuration change was made.

In some embodiments, the subsystem report 706 can be used to compare a current configuration of a subsystem to a former configuration of a subsystem. There can be a master (e.g., default, stock, etc.) configuration that is the basis for comparison relative to current configurations of subsystems. If the subsystem report 706 indicates that the master configuration outperforms the current configuration, the user can have the option to revert the configuration of the subsystem back to the master configuration.

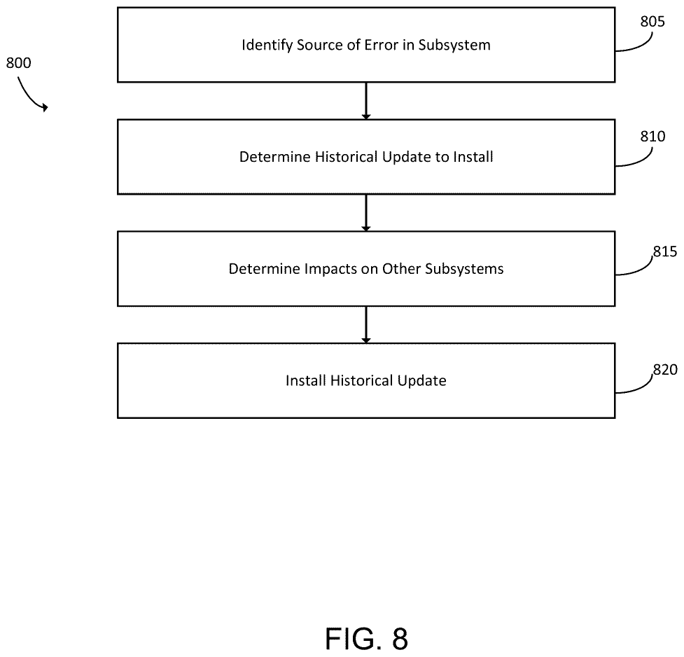

Referring now to FIG. 8, depicted is a flow diagram of a method 800 for re-installing a historical update on a functional component, according to some embodiments. While the description below refers to operations of an edge device, such operations can be executed by one or more edge devices, cloud computing systems, etc. or combination thereof (e.g., distributed across devices and system), in various embodiments within the scope of the present disclosure. At step 805, the edge device (e.g., edge device 204) identifies a source of error in a subsystem (e.g., subsystem 406). The source of error may be due to a first functional component in the subsystem having an update (e.g., functional element, software, etc.) that is not compatible with a second functional component. At step 810, if the edge device determines that the source of error is due to incompatibility between functional components, the edge device determines a historical update to install on the functional component that would make the functional components of the subsystem compatible, while still maintaining the desired operation of the subsystem.

At step 815, after the edge device determines the historical update for installation, the edge device determines whether the historical update would impact operation of other subsystems that include the functional component. If the edge device determines that the historical update would interrupt or otherwise disable other subsystems, the edge device may determine other updates to be installed on the functional component and/or other subsystems that would allow all subsystems to operate properly. At step 820, the edge device installs the historical update along with any other necessary updates necessary to resolve the error in the subsystem. If multiple updates are installed, the updates may be installed individually, or at the same time (e.g., via the revision registry 510).

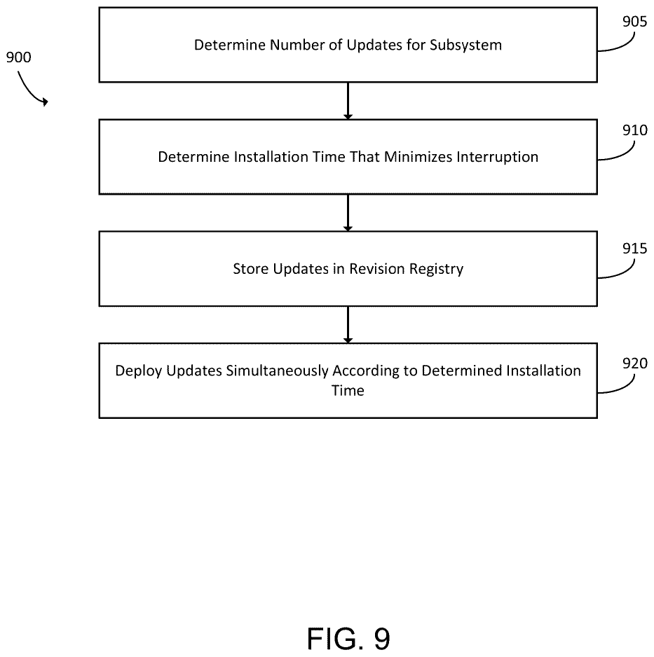

Referring to FIG. 9, depicted is a flow diagram of a method 900 for deploying updates to a subsystem while minimizing interruption time to the subsystem. While the description below refers to operations of an edge device, such operations can be executed by one or more edge devices, cloud computing systems, etc. or combination thereof (e.g., distributed across devices and system), in various embodiments within the scope of the present disclosure. At step 905, the edge device determines the number of updates to be installed on the subsystem. The number of updates can be based on user initiated updates (e.g., via the user device 512, via the user device 700). The number of updates can be based on automatic updates initiated by the cloud computing system (e.g., cloud computing system 202).

At step 910, the edge device determines a time to install the updates that minimizes interruption to the operation of the subsystem. The edge device can be configured to determine whether the updates to the subsystem will interrupt operation of the subsystem. If the edge device determines that the updates will interrupt operation, the edge device can process historical data of the subsystem to determine an optimal time to install the updates. The edge device, user device, and/or cloud computing system can be configured to store historical operation data associated with each subsystem.

At step 915, the edge device stores the updates in the revision registry (e.g., revision registry 510). The revision registry is configured to deploy the updates at a predetermined time selected by the edge device 204. At step 920, at the time selected by the edge device, the revision registry is configured to deploy the updates to the subsystem simultaneously. By installing the updates at the same time, interruption to the subsystem can be minimized. The edge device may transmit a message to be displayed on the user device indicating that the updates are being installed.

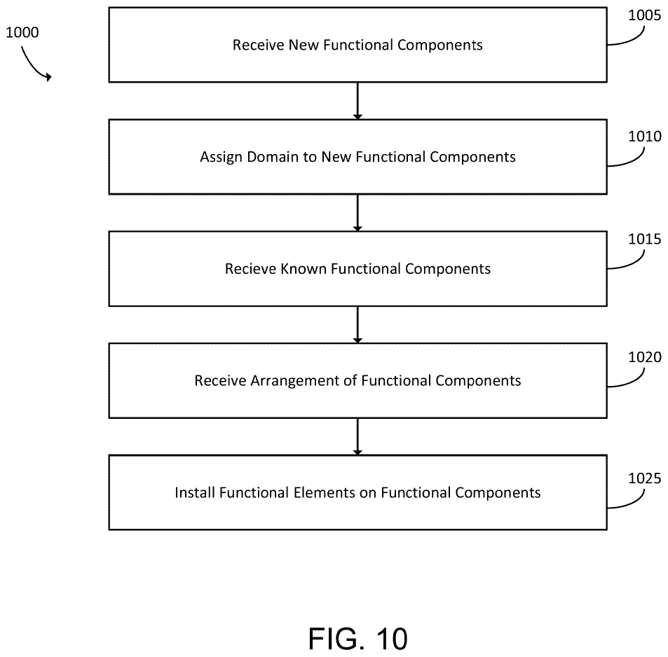

Referring now to FIG. 10, depicted is a flow diagram for a method 1000 for configuring new subsystems. While the description below refers to operations of an edge device, such operations can be executed by one or more edge devices, cloud computing systems, etc. or combination thereof (e.g., distributed across devices and system), in various embodiments within the scope of the present disclosure. At step 1005, the edge device (e.g., edge device 204) may receive (e.g., from a user device) information associated with a new functional component to be added to the architecture registry (e.g., architecture registry 502). The information associated with the new functional component can include information related to operation, software requirements, power usage, and other identifying information of the new functional component. At step 1010, the edge device assigns a domain to the new functional component. The assigned domain may be based on a user input, or be based on the information associated with the new functional component. The assigned domain may be stored in the domain registry (e.g., domain registry 504).

At step 1015, the edge device receives known functional component to be added to the subsystem. The edge device may ensure that the user (e.g., requestor) is authorized to access the domain of each known functional component. At step 1020, the edge device receives (e.g., from the user/requestor) the arrangement (e.g., hierarchy) of functional components for the new subsystem. The edge device may determine whether the arrangement of functional components are compatible with each other, and may determine whether updates are necessary to ensure that the new subsystem executes the desired operation. At step 1025, if the edge device determines that the functional components should receive updates (e.g., functional elements), the edge device can install the updates on the functional components. The updates may be installed from the content repository (e.g., content repository 506), or the cloud computing system (e.g., cloud computing system 202).

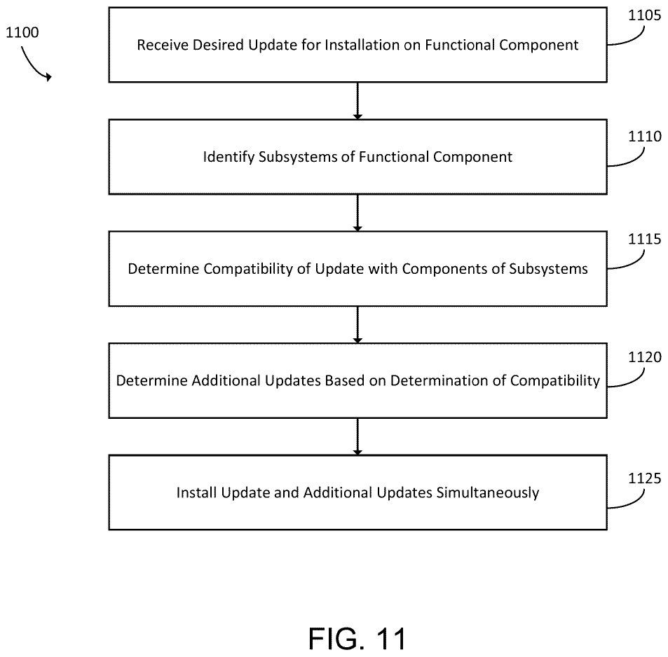

Referring now to FIG. 11, depicted is a flow diagram of a method 1100 for maintaining compatibility of functional components across subsystems when installing updates. While the description below refers to operations of an edge device, such operations can be executed by one or more edge devices, cloud computing systems, etc. or combination thereof (e.g., distributed across devices and system), in various embodiments within the scope of the present disclosure. At step 1105, the edge device (e.g., edge device 204) receive the desired update for installation on a functional component. The desired update can be indicated by a user device or by a cloud computing system (e.g., cloud computing system 202). At step 1110, the edge device identifies (e.g., via the architecture registry 502) the subsystems that include the functional component to be updated. At step 1115, upon identifying the subsystems that include the functional component, the edge device determines whether the updated functional component would still be compatible with other components of the subsystems.

At step 1120, if the edge device determines that the updated functional component would not be compatible with all functional components of the subsystems, the edge device can determine if additional updates can be installed to re-establish compatibility. At step 1125, the edge device can install the update and the additional updates (if necessary) simultaneously (e.g., via the revision registry 510). After installation, the edge device can perform additional checks and compatibility tests to ensure that compatibility is maintained after the update(s).

### Configuration of Exemplary Embodiments

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining can be stationary (i.e., permanent or fixed) or moveable (i.e., removable or releasable). Such joining can be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (i.e., directly coupled), the generic definition of “coupled” provided above is modified by the plain language meaning of the additional term (i.e., “directly coupled” means the joining of two members without any separate intervening member), resulting in a narrower definition than the generic definition of “coupled” provided above. Such coupling can be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element can be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Although the figures and description can illustrate a specific order of method steps, the order of such steps can differ from what is depicted and described, unless specified differently above. Also, two or more steps can be performed concurrently or with partial concurrence, unless specified differently above. Such variation can depend, for example, on the software and hardware systems chosen and on designer choice. All such variations are within the scope of the disclosure.

It is important to note that the construction and arrangement of the apparatus as shown in the various exemplary embodiments is illustrative only. Additionally, any element disclosed in one embodiment can be incorporated or utilized with any other embodiment disclosed herein. Although only one example of an element from one embodiment that can be incorporated or utilized in another embodiment has been described above, it should be appreciated that other elements of the various embodiments can be incorporated or utilized with any of the other embodiments disclosed herein.

What is claimed is:

1. A system comprising:
a subsystem comprising a digital functional component and a non-digital functional component, the subsystem configured to execute an operation involving both the digital functional component and the non-digital functional component; and
an edge device communicatively coupled to the subsystem and configured to:
determine a desired update for the digital functional component;
retrieve the desired update from a content repository;
determine whether the desired update would interrupt the operation; and
install the desired update on the digital functional component, responsive to a determination that the operation would not be interrupted.

2. The system of claim 1, wherein the edge device is programmed to determine whether the desired update would interrupt the operation by:
determining, based on an architecture registry, whether the subsystem comprises the digital functional component;
determining, based on the architecture registry, a hierarchy of the subsystem, wherein the hierarchy indicates a plurality of functional components dependent on the digital functional component; and
determining, based on the hierarchy, whether the desired update would interrupt the operation of the subsystem.

3. The system of claim 2, wherein the edge device is further programmed to:
determine, based on the hierarchy of the subsystem, whether the plurality of functional components is compatible with the desired update;
determine an additional update for the plurality of functional components, responsive to a determination that the plurality of functional components is not compatible with the desired update; and
install the additional update simultaneously with the desired update.

4. The system of claim 1, wherein the digital functional component comprises a functional element configured to execute a part of the operation.

5. The system of claim 4, wherein the functional element is one of a plurality of functional elements, and wherein the plurality of functional elements comprises any of a protocol, an adapter, an analysis block, a visualization, an interface, a configuration, or an OS patch.

6. The system of claim 4, wherein the functional element is a first functional element, and wherein the part of the operation is a first part of the operation, the digital functional component further comprising a second functional element configured to execute a second part of the operation.

7. The system of claim 4, wherein the functional element is a first functional element, wherein the desired update comprises a second functional element.

8. The system of claim 1, wherein the non-digital functional component is configured to execute a mechanical function providing a part of the operation.

9. The system of claim 8, wherein a hierarchy of the subsystem defines the non-digital functional component as being dependent on the digital functional component, such that the digital functional component controls performance of the non-digital functional component.

10. The system of claim 1, wherein the edge device comprises a revision registry configured to store scheduled updates for the digital functional component.

11. The system of claim 10, wherein the revision registry is further configured to store a plurality of scheduled updates for a plurality of functional components for the subsystem, and wherein the plurality of scheduled updates is installed simultaneously.

12. The system of claim 1, wherein the edge device comprises a revision history configured to store past updates for the digital functional component.

13. The system of claim 12, wherein the edge device is further programmed to:
identify a desired past update of the revision history to upload onto the digital functional component; and
upload the desired past update onto the digital functional component.

14. The system of claim 1, wherein the edge device is programmed to install the desired update by transmitting the desired update via a networked connection between the edge device and the digital functional component.

15. The system of claim 1, wherein the edge device is programmed to install the desired update by:
uploading the desired update from the edge device onto an external storage device; and
downloading the desired update from the external storage device onto a device maintaining the digital functional component.

16. The system of claim 1, wherein the digital functional component is assigned to a first domain, and wherein the first domain is stored in a domain registry of the edge device.

17. The system of claim 16, wherein the first domain, and wherein the edge device is programmed to determine the desired update for the digital functional component based on a request indicating the digital functional component, the desired update, and an identifier of a user, wherein the identifier of the user indicates a second domain of the user.

18. The system of claim 17, wherein the edge device is programmed to install the desired update by:
identifying, based on the identifier of the user, the second domain of the user;
determining whether the first domain matches the second domain; and
installing the desired update, responsive to a determination that the first domain matches the second domain.

19. The system of claim 17, wherein the edge device is programmed to retrieve the desired update from the content repository responsive to determining that the identifier of the user indicates that the user is authorized to access the domain.

20. The system of claim 17, further comprising a user device, wherein the request is transmitted from the user device to the edge device.

21. The system of claim 20, wherein the user device is configured to display a dashboard comprising information relating to the subsystem.

22. The system of claim 1, comprising a second subsystem comprising the digital functional component, the subsystem configured to execute a second operation.

23. The system of claim 1, wherein the edge device is programmed to determine whether the desired update would interrupt the operation by:
determining an installation time for the desired update;
determining whether the desired update will disable the digital functional component during the installation time;
determining an expected operation of the subsystem during the installation time; and
determining whether the expected operation of the subsystem can be performed during the installation time, responsive to a determination that the desired update will disable the digital functional component.

24. A method of using an edge device communicatively coupled to a subsystem, the subsystem comprising a digital functional component and a non-digital functional component, the subsystem configured to execute an operation involving both the digital functional component and the non-digital functional component, the method comprising:
determining a desired update for the digital functional component;
retrieving the desired update from a content repository;
determining whether the desired update would interrupt the operation; and
installing the desired update on the digital functional component, responsive to a determination that the operation would not be interrupted.

25. An edge device in communication with a subsystem comprising a digital functional component and a non-digital functional component, the subsystem configured to execute an operation involving both the digital functional component and the non-digital functional component, the edge device comprising:
a processor configured to:
determine a desired update for the digital functional component;
retrieve the desired update from a content repository;
determine whether the desired update would interrupt the operation; and
install the desired update on the digital functional component, responsive to a determination that the operation would not be interrupted.
